(19) United States
(12) Patent Application Publication
(10) Pub. No.: US 2015/0369211 A1
(43) Pub. Date: Dec. 24, 2015

(54) WIND BLADE TIP JOINT

(71) Applicant: General Electric Company, Schenectady, NY (US)

(72) Inventor: Thomas Merzhaeuser, Munchen (DE)

(21) Appl. No.: 14/308,792

(22) Filed: Jun. 19, 2014

(51) Int. Cl. F03D 1/06; F03D 1/00; F03D 11/00

(52) U.S. Cl. CPC F03D 1/0675; F03D 11/0033; F03D 11/0091; F03D 1/001

(57) ABSTRACT

A wind turbine blade includes a first blade segment and a second blade segment extending in opposite directions from a chord-wise joint. The first blade segment includes a beam structure extending lengthways that structurally connects with the second blade segment at a receiving section, wherein the beam structure forms a portion of an internal support structure and includes a shear web connected with a suction side spar cap and a pressure side spar cap. The present technology also includes multiple first bolt joints located at a first end of the beam structure for connecting with the receiving end of the second blade segment and multiple second bolt joints located at the chord-wise joint, wherein the multiple first bolt joints located at the first end of beam structure are separated pan-wise with the multiple second bolt joints located at the chord-wise joint.

### BACKGROUND

The present application relates generally to wind turbines and more particularly relates to a wind blade tip joint for a wind turbine.

Most environment friendly energy sources presently available come from wind power that is considered to be one of the cleanest. Wind turbines generate electricity by effectively harnessing energy in the wind via a rotor having a set of rotor blades that turns a gearbox and generator, thereby converting mechanical energy to electrical energy that may be deployed to a utility grid. The construction of a modern wind turbine rotor blade generally includes skin or shell components, span-wise extending spar caps, and one or more shear webs.

In recent years, wind turbines for wind power generation have increased in size to achieve improvement in power generation efficiency and to increase the amount of power generation. Along with the increase in size of wind turbines for wind power generation, wind turbine rotor blades have also increased in size, for example, a minimum blade length of 40 meters. When the wind turbine rotor blade is increased in size as described above, various difficulties, such as a difficulty in integral manufacture and a difficulty in conveyance along with difficulties in securing roads and trucks, etc., occur.

There is therefore a desire for a wind blade that is separated in a longitudinal direction for allowing easy handling and transportation and a method for assembling such a wind blade.

### BRIEF DESCRIPTION

In accordance with an example of the present technology, a wind turbine blade includes a first blade segment and a second blade segment extending in opposite directions from a chord-wise joint. Each of the blade segments having a pressure side shell member, a suction side shell member, and an internal support structure. The first blade segment includes a beam structure extending lengthways that structurally connects with the second blade segment at a receiving section, wherein the beam structure forms a portion of the internal support structure and includes a shear web connected with a suction side spar cap and a pressure side spar cap. The present technology also includes multiple first bolt joints located at a first end of the beam structure for connecting with the receiving end of the second blade segment and multiple second bolt joints located at the chord-wise joint, wherein the multiple first bolt joints located at the first end of beam structure are separated span-wise with the multiple second bolt joints located at the chord-wise joint.

In accordance with an example of the present technology, a method of assembling a wind turbine blade includes arranging a first blade segment and a second blade segment in opposite directions from a chord-wise joint, each of the blade segments having a pressure side shell member, a suction side shell member, and an internal support structure. The method also includes inserting a beam structure extending lengthways from the first blade segment into a receiving section of the second blade segment. Further, the method includes attaching a free end of the beam structure with the receiving end of the second blade segment using multiple first bolt joints. Furthermore, the method includes connecting both the blade segments using multiple second bolt joints located at the chord-wise joint, wherein the multiple first bolt joints located at the first end of beam structure are separated span-wise with the multiple second bolt joints located at the chord-wise joint.

In accordance with another example of the present technology, a wind turbine includes multiple wind blades. Each of the multiple wind blades includes a first blade segment and a second blade segment extending in opposite directions from a chord-wise joint, each of the blade segments having a pressure side shell member, a suction side shell member, and an internal support structure. The first blade segment includes a beam structure extending lengthways that structurally connects with the second blade segment at a receiving section. The beam structure forms a portion of the internal support structure and comprises a shear web connected with a suction side spar cap and a pressure side spar cap. The wind blade also includes multiple first bolt joints located at a first end of the beam structure for connecting with the receiving end of the second blade segment and multiple second bolt joints located at the chord-wise joint, wherein the multiple first bolt joints located at the first end of beam structure are separated span-wise with the multiple second bolt joints located at the chord-wise joint.

### DRAWINGS

These and other features, aspects, and advantages of the present invention will become better understood when the following detailed description is read with reference to the accompanying drawings in which like characters represent like parts throughout the drawings, wherein:

FIG. 1 is a side view of an exemplary wind turbine in accordance with an example of the present technology.

FIG. 2 is a plan view of a rotor blade having a first blade segment and a second blade segment in accordance with an example of the present technology.

FIG. 3 is a perspective view of a section of the first blade segment in accordance with an example of the present technology.

FIG. 4 is a perspective view of a section of the second blade segment at the chord-wise joint in accordance with an example of the present technology.

FIG. 5 shows an assembly of the wind blade having the first blade segment joined with the second blade segment in accordance with an example of the present technology.

FIG. 6 shows an exploded perspective view of the multiple supporting structures of the assembly of the rotor blade in accordance with an example of the present technology.

FIG. 7 is a flow chart of a method of assembling a wind turbine blade in accordance with an example of the present technology.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Further, the terms “wind blade” and “rotor blade” are used interchangeably in the present invention. Any examples of operating parameters are not exclusive of other parameters of the disclosed embodiments.

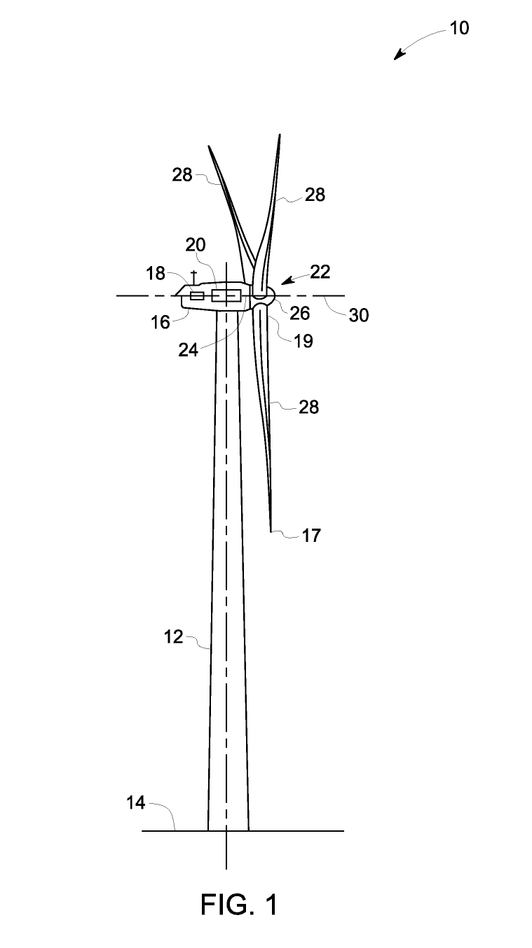

FIG. 1 is a side view of an exemplary wind turbine 10 in accordance with an embodiment of the present invention. In this embodiment, the wind turbine 10 is a horizontal-axis wind turbine. Alternatively, the wind turbine 10 may be a vertical-axis wind turbine. In the present embodiment, the wind turbine 10 includes a tower 12 that extends from a support surface 14, a nacelle 16 mounted on the tower 12, a generator 18 positioned within the nacelle 16, a gearbox 20 coupled to the generator 18, and a rotor 22 that is rotationally coupled to the gearbox 20 with a rotor shaft 24. The rotor 22 includes a rotatable hub 26 and at least one rotor blade 28 coupled to and extending outward from the rotatable hub 26. As shown, the rotor blade 28 includes a blade tip 17 to a blade root 19.

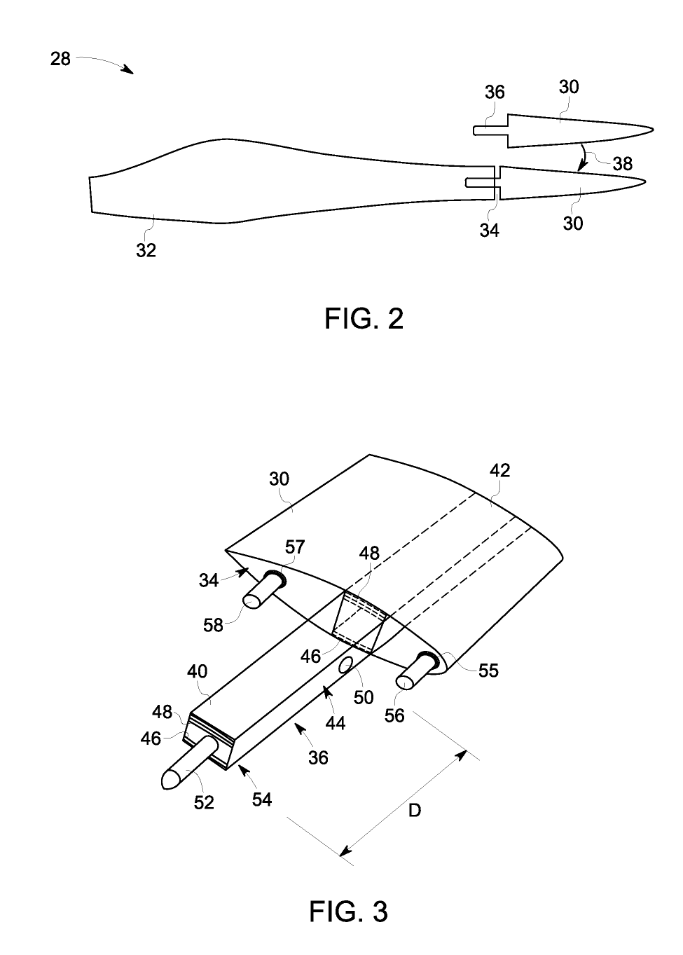

FIG. 2 is a plan view of a rotor blade 28 having a first blade segment 30 and a second blade segment 32 in accordance with an example of the present technology. The first blade segment 30 and the second blade segment 32 extends in opposite directions from a chord-wise joint 34. Each of the blade segments 30, 32 includes a pressure side shell member and a suction side shell member. The first blade segment 30 and the second blade segment 32 are connected by at least an internal support structure 36 extending into both blade segments 30, 32 to facilitate joining of the blade segments 30, 32. The arrow 38 shows that the segmented rotor blade 28 in the illustrated example includes two blade segments 30, 32 and that these blade segments 20, 32 are joined by inserting the internal support structure 36 into the second blade segment 32.

FIG. 3 is a perspective view of a section of the first blade segment 30 in accordance with an example of the present technology. The first blade segment 30 includes a beam structure 40 that forms a portion of the internal support structure 36 and extends lengthways for structurally connecting with the second blade segment 32. The beam structure 40 forms a part of the first blade segment 30 having an extension protruding from a spar section 42, thereby forming an extending spar section. The beam structure 40 includes a shear web 44 connected with a suction side spar cap 46 and a pressure side spar cap 48.

Further, the first blade segment 30 includes one or more first bolt joints towards a first end 54 of the beam structure 40. In a non-limiting example, the bolt joint includes a pin that is in a tight interference fit with a bush. As shown, the one or more bolt joints includes one bolt tube 52 located on the beam structure 40. As shown, the bolt tube 52 is oriented in a span-wise direction. The first blade segment 30 also includes one bolt joint slot 50 located on the beam structure proximate to the chord-wise joint 34. This bolt joint slot 50 is oriented in a chord-wise direction. In one example, there may be a bushing within the bolt joint slot 50 arranged in a tight interference fit with a bolt tube or pin (shown as pin 53 in FIG. 6). Further, the first blade segment 30 includes multiple second bolt joint tubes 56, 58 located at the chord-wise joint 34. The multiple second bolt joint tubes 56, 58 include a leading edge bolt joint tube 56 and a trailing edge bolt joint tube 58. Each of the leading edge bolt joint tube 56 and the trailing edge bolt joint tube 58 is oriented in a span-wise direction. In one example, each of the multiple second bolt joint tubes 56, 58 include multiple flanges 55, 57 respectively that are configured to distribute compression loads at the chord-wise joint 34.

It is to be noted that the bolt tube 52 located at the first end of beam structure 40 is separated span-wise with the multiple second bolt joint tubes 56, 58 located at the chord-wise joint 34 by an optimal distance D. This optimal distance D may be such that the chord-wise joint 34 is able to withstand substantial bending moments caused due to shear loads acting on the chord-wise joint 34. In one non-limiting example, each of the bolt joints connecting the first and second blade segments 30, 32 may include an interference-fit steel bushed joint.

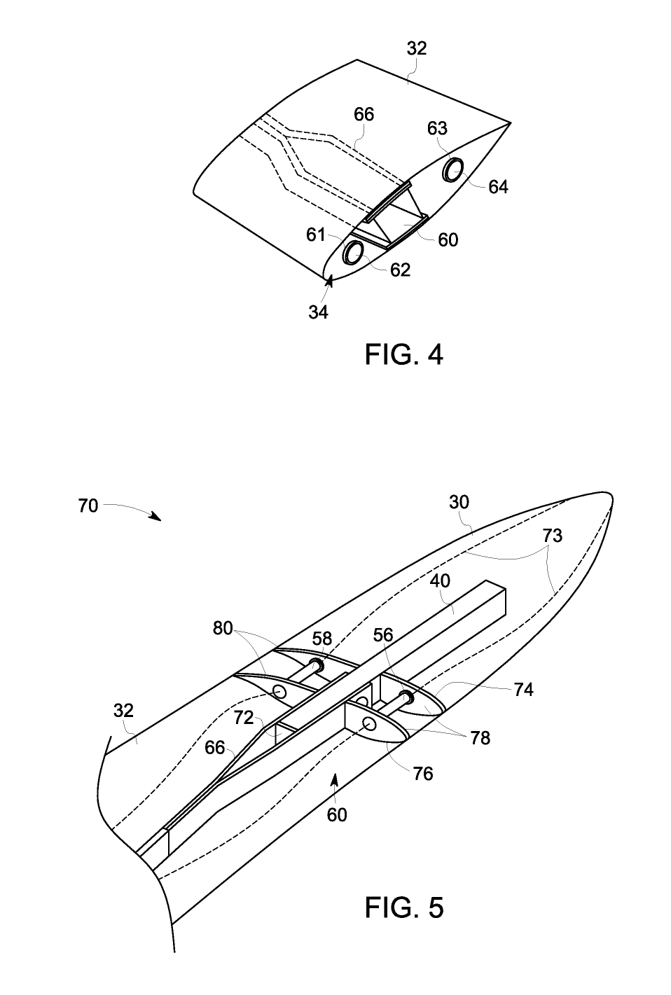

FIG. 4 is a perspective view of a section of the second blade segment 32 at the chord-wise joint 34 in accordance with an example of the present technology. The second blade segment 32 shows a receiving section 60 extending lengthways within the second blade segment 32 for receiving the beam structure 40 of the first blade segment 30. The receiving section 60 includes multiple spar structures 66 that extend lengthways for connecting with the beam structure 40 of the first blade segment 30. As shown, the second blade segment 32 further includes bolt joint slots 62, 64 for receiving bolt tubes 56, 58 (shown in FIG. 3) of the first blade segment 30 and forming tight interference fittings. In one example, each of the multiple bolt joint slots 62, 64 include multiple flanges 61, 63 respectively that are configured to distribute compression loads at the chord-wise joint 34.

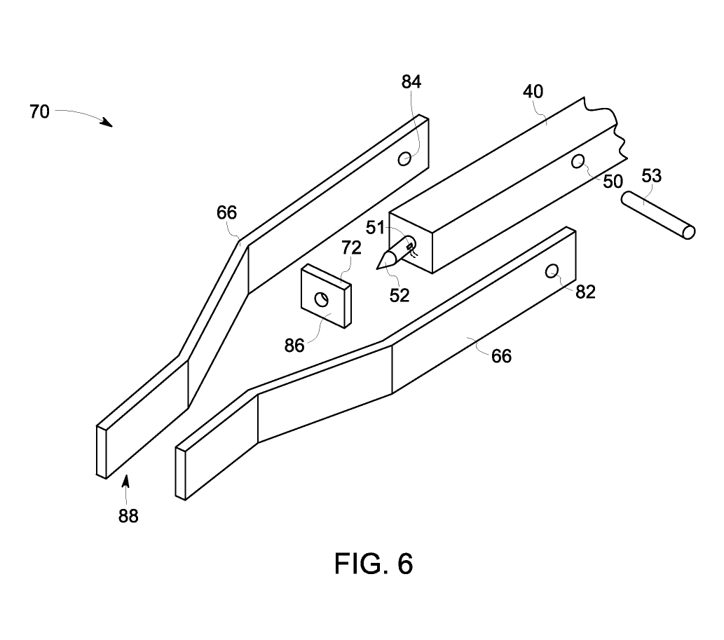

FIG. 5 shows an assembly 70 of the wind blade 28 having the first blade segment 30 joined with the second blade segment 32 in accordance with an example of the present technology. In this example, the assembly 70 illustrates multiple supporting structures beneath outer shell members of the rotor blade 28 having the first blade segment 30 joined with the second blade segment 32. As shown, the receiving section 60 includes the multiple spar structures 66 extending lengthways and supports the beam structure 40. The receiving section 60 also includes a rectangular fastening element 72 that connects with the bolt tube 52 of the beam structure 40 in the span-wise direction. Further, both the first and the second blade segment 30, 32 includes chord-wise members 74, 76 respectively at the chord-wise joint 34. The chord-wise members 74, 76 includes leading edge bolt openings 78 and trailing edge bolt openings 80 that allows bolt joint connections between the first and second blade segments 30, 32. As shown, the chord-wise members 74, 76 are connected by bolt tubes 56 and 68 that are in tight interference fit with bushing located in the leading edge bolt openings 78 and trailing edge bolt openings 80. In a non-limiting example, each of the spar structures 66, the rectangular fastening element 72, and the chord-wise members 74, 76 are made up of glass reinforced fibers. In this example, the assembly 70 also includes multiple lightening receptor cables 73 that are embedded between the multiple bolt tubes or pins 56, 58 and the bushing connections attached to the chord-wise members 74, 76.

FIG. 6 shows an exploded perspective view of the multiple supporting structures of the assembly 70 towards the receiving section 60 of the rotor blade 28. As shown, a pair of spar structures 66 is configured to receive the beam structure 40 and includes bolt joint slots 82, 84 that are aligned with the bolt joint slot 50 of the beam structure 40 through which a bolt tube or pin 53 is inserted and remains in a tight interference fit such that spar structures 66 and the beam structure 40 are joined together by during assembling. FIG. 6 also shows the rectangular fastening element 72 that includes a bolt joint slot 86 configured for receiving the bolt tube 52 of the beam structure 40 forming a tight interference fit bolted joint. Further, the pair of spar structures 66 is joined together at one end 88 using a suitable adhesive material or an elastomeric seal. In one example, a sensor element 51 is disposed in the pin or bolt tube 52. The sensor element may help in receiving and sending signals to a control unit (not shown) of the wind turbine 10 (as shown in FIG. 1), which signals may enable sensing multiple parameters including blade loads or stresses. This may help in effective operation of the wind turbine 10 (shown in FIG. 1).

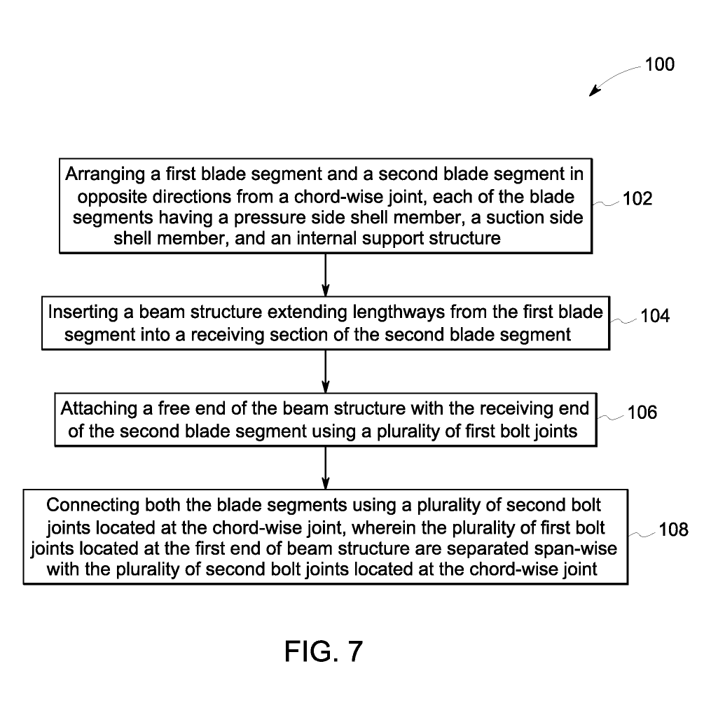

FIG. 7 is a flow chart 100 of a method of assembling a wind turbine blade in accordance with an example of the present technology. At step 102, the method includes arranging a first blade segment and a second blade segment in opposite directions from a chord-wise joint, each of the blade segments having a pressure side shell member, a suction side shell member, and an internal support structure. At step 104, the method also includes inserting a beam structure extending lengthways from the first blade segment into a receiving section of the second blade segment. Further at step 106, the method includes attaching a free end of the beam structure with the receiving end of the second blade segment using multiple first bolt joints. The method also includes attaching the free end of the beam structure with the receiving end of the second blade segment using one first of the multiple first bolt joints that is oriented in a span-wise direction and one second of the multiple first bolt joints in a chord-wise direction. Furthermore, at step 108, the method includes connecting both the blade segments using multiple second bolt joints located at the chord-wise joint. The multiple second bolt joints are oriented in a span-wise direction and include a leading edge bolt joint and a trailing edge bolt joint. The multiple first bolt joints located at the first end of beam structure are separated span-wise with the multiple second bolt joints located at the chord-wise joint.

Advantageously, the present technology ensures efficient reduction of connecting loads, leading to simplified moment flow between the multiple supporting structures of the wind blade. Further, the present technology ensures low cost, reliable, and scalable connections. Due to the customizable blade geometry and segmented blade parts, there is reduction in transportation costs. Furthermore, the easy handling and assembling of the wind blade leads to reduction of turbine down time during wind blade maintenance.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A wind turbine blade, comprising:
a first blade segment and a second blade segment extending in opposite directions from a chord-wise joint, each of the blade segments having a pressure side shell member, a suction side shell member, and an internal support structure;
the first blade segment comprising a beam structure extending lengthways that structurally connects with the second blade segment at a receiving section, wherein the beam structure forms a portion of the internal support structure and comprises a shear web connected with a suction side spar cap and a pressure side spar cap;
one or more first bolt joints located at a first end of the beam structure for connecting with the receiving end of the second blade segment; and
a plurality of second bolt joints located at the chord-wise joint, wherein the plurality of first bolt joints located at the first end of beam structure are separated span-wise with the plurality of second bolt joints located at the chord-wise joint.

2. The wind turbine blade of claim 1, wherein the plurality of second bolt joints comprises a leading edge bolt joint and a trailing edge bolt joint.

3. The wind turbine blade of claim 2, wherein each of the leading edge bolt joint and the trailing edge bolt joint is oriented in a span-wise direction and comprises one or more flanges that are configured to distribute compression loads at the chord-wise joint.

4. The wind turbine blade of claim 1, wherein the one first bolt joint located at the first end of the beam structure is oriented in a span-wise direction.

5. The wind turbine blade of claim 4, further comprising a sensor element. disposed on the one first bolt joint for measuring multiple parameters.

6. The wind turbine blade of claim 5, wherein the multiple parameters measured by the sensor element comprises blade loads or stresses.

7. The wind turbine blade of claim 1, wherein one of the plurality of second bolt joints located proximate to the chord-wise joint on the beam structure is oriented in a chord-wise direction.

8. The wind turbine blade of claim 1, wherein the receiving section of the second blade segment comprises a plurality of spar structures extending lengthways for connecting with the beam structure of the first blade segment using one of the plurality of first bolt joints in the chord-wise direction.

9. The wind turbine blade of claim 1, wherein the receiving, section of the second blade segment comprises a rectangular fastenting element that connects with the beam structure of the first blade section using one of the plurality of first bolt joints in the span-wise direction.

10. The wind turbine blade of claim 1, further comprising a plurality of chordwise members at the chord-wise joint that are made up of fiber reinforced plastic for supporting the beam structure.

11. The wind turbine blade of claim 10, further comprising a plurality of lightening receptor cables that are embedded between the plurality of second bolt tubes or pins and a plurality of bushing connections attached to the plurality of chordwise members.

12. A method of assembling a wind turbine blade, the method comprising:
arranging a first blade segment and a second blade segment in opposite directions from a chord-wise joint, each of the blade segments having a pressure side shell member, a suction side shell member, and an internal support structure;
inserting a beam structure extending lengthways from the first blade segment into a receiving section of the second blade segment;
attaching a free end of the beam structure with the receiving end of the second blade segment using one or more first bolt joints; and
connecting both the blade segments using a plurality of second bolt joints located at the chord-wise joint, wherein the plurality of first bolt joints located at the first end of beam structure are separated span-wise with the plurality of second bolt joints located at the chord-wise joint.

13. The method of claim 12, further comprising attaching the free end of the beam structure with the receiving end of the second blade segment using the one first bolt joint that is oriented in a span-wise direction.

14. The method of claim 12, wherein the plurality of second bolt joints comprises a leading edge bolt join(and a trailing edge bolt joint oriented in a span-wise direction.

15. The method of claim 12, wherein the plurality of second bolt joints comprises a bolt joint located on the beam structure in a chord-wise direction proximate to the chord-wise joint.

16. A wind turbine comprising:
a plurality of wind blades, wherein each of the plurality of wind blades comprising:
a first blade segment and a second blade segment extending in opposite directions from a chord-wise joint, each of the blade segments having a pressure side shell member, a suction side shell member, and an internal support structure;
the first blade segment comprising a beam structure extending lengthways that structurally connects with the second blade segment at a receiving section, wherein the beam structure forms a portion of the internal support structure and comprises a shear web connected with a suction side spar cap and a pressure side spar cap;
one or more first bolt s located at a first end of the beam structure for connecting with the receiving end of the second blade segment; and
a plurality of second bolt joints located at the chord-wise joint, wherein the plurality of first bolt joints located at the first end of beam structure are separated span-wise with the plurality of second bolt joints located at the chord-wise joint.

17. The wind turbine of claim 16, wherein the plurality of second bolt joints comprises a leading edge bolt joint and a trailing edge bolt joint arranged symmetrically about the beam structure of the first blade segment and configured for withstanding torsion moments.

18. The wind turbine of claim 16, wherein the one first bolt joint located at the first end of the beam structure is oriented in a span-wise direction.

19. The wind turbine of claim 16, further comprising a plurality of chordwise members at the chord-wise joint that are made up of fiber reinforced plastic for supporting the beam structure.

20. The wind turbine of claim 19, further comprising a plurality of lightening receptor cables that are embedded between the plurality of second bolt tubes or pins and a plurality of bushing connections attached to the plurality of chordwise members.
